(19) United States
(12) Patent Application Publication
(10) Pub. No.: US 2023/0183462 A1
(43) Pub. Date: Jun. 15, 2023

(54) HIGHLY FILLED AND FLEXIBLE POLYOLEFIN COMPOSITION

(71) Applicant: Basell Poliolefine Italia S.r.l., Milan (IT)

(72) Inventors: Roberta Marchini, Ferrara (IT); Gianluca Musacchi, Ferrara (IT); Stefano Pasquali, Ferrara (IT)

(73) Assignee: Basell Poliolefine Italia S.r.l., Milan (IT)

(21) Appl. No.: 17/925,421

(22) PCT Filed: May 18, 2021
(86) PCT No.: PCT/EP2021/063076

§ 371 Date: Nov. 15, 2022

(30) Foreign Application Priority Data
May 22, 2020 (EP) 20176046.9

(51) Int. Cl. C08L 23/20; C08K 3/22

(52) U.S. Cl. CPC C08L 23/20; C08K 3/22; C08K 2003/2224; C08K 2201/005; C08L 2201/02; C08L 2203/202

(57) ABSTRACT

A polyolefin composition made from or containing:

a) from 85% to 98% by weight of a composition made from or containing:
A) a copolymer of butene-1 with ethylene having a copolymerized ethylene content of up to 18% by mole and no melting peak detectable at the DSC at the second heating scan; and
B) an inorganic filler;
wherein the B)/A) weight ratio being from 0.3 to 4; and
   b) from 2% to 15% by weight of an additional polyolefin different from A).

### FIELD OF THE INVENTION

In general, the present disclosure relates to the field of chemistry. More specifically, the present disclosure relates to polymer chemistry. In particular, the present disclosure relates to a polyolefin composition made from or containing inorganic fillers.

### BACKGROUND OF THE INVENTION

Thermoplastic polyolefin compositions. having low flexural modulus and shore hardness values, are used in many application fields.

In some instances, flexible polymer materials are used in extrusion coating, electrical wires and cables covering, as well as for packaging and in the medical field.

In some instances, mineral fillers, such as aluminum and magnesium hydroxides or calcium carbonate, are used at high concentration levels to impart self-extinguishing properties or improve application-related physical properties.

In some instances, these mineral fillers use high loading. In some instances, up to 65-70% by weight of filler is used. In some instances, this loading level has a negative influence on the processing of the polymer and on the physical-mechanical properties of compounds, providing lower elongation at break, lower tensile strength, and higher brittleness.

### SUMMARY OF THE INVENTION

In a general embodiment, the present disclosure provides a polyolefin composition made from or containing:

a) from 85% to 98% by weight of a composition made from or containing:

A) a copolymer of butene-1 with ethylene having a copolymerized ethylene content of up to 18% by mole and no melting peak detectable at the DSC at the second heating scan; and

B) an inorganic filler;

wherein the B)/A) weight ratio being from 0.3 to 4; and

b) from 2% to 15% by weight of an additional polyolefin different from A);
wherein the amounts of a) and b) refer to the total weight of a)+b) and the DSC second heating scan is carried out at a heating rate of 10° C. per minute.

### DETAILED DESCRIPTION OF THE INVENTION

In some embodiments, the present disclosure provides a polyolefin composition made from or containing:

a) from 85% to 98% by weight, alternatively from 86% to 98% by weight, of a composition comprising:

A) a copolymer of butene-1 with ethylene having a copolymerized ethylene content of up to 18% by mole and no melting peak detectable at the DSC at the second heating scan; and

B) an inorganic filler, alternatively selected from flame-retardant inorganic fillers;

wherein the B)/A) weight ratio being from 0.3 to 4, alternatively from 0.5 to 4, alternatively from 0.3 to 3, alternatively 0.5 to 3, alternatively from 0.3 to 2.8, alternatively from 0.5 to 2.8, alternatively from 0.3 to 2.2, alternatively from 0.5 to 2.2; and

b) from 2% to 15% by weight, alternatively from 2% to 14% by weight, of an additional polyolefin different from A);
wherein the amounts of a) and b) refer to the total weight of a)+b) and the DSC second heating scan is carried out at a heating rate of 10° C. per minute.

In some embodiments, the present polyolefin composition contains 20% by weight or more, alternatively 27% by weight or more, of A) with respect to the total weight of the composition.

In some embodiments, amounts of A) are from 20% to 45% by weight, alternatively from 27% to 45% by weight, with respect to the total weight of the polyolefin composition.

In some embodiments, amounts of B) are from 40% to 65% by weight with respect to the total weight of the polyolefin composition.

In some embodiments, values of MIE for the present polyolefin composition are of equal to or greater than 0.05 g/10 min., alternatively equal to or greater than 0.25 g/10 min., alternatively from 0.05 to 5 g/10 min., alternatively from 0.25 to 5 g/10 min., alternatively from 0.5 to 5 g/10 min., where MIE is the melt flow index at 190° C. with a load of 2.16 kg, determined according to ISO 1133-2:2011.

In some embodiments, values of Flexural Elastic Modulus for the present polyolefin composition are equal to or less than 600 MPa, alternatively equal to or less than 400 MPa, alternatively the lower limit being 80 MPa, measured according to norm ISO 178, 10 days after molding.

In some embodiments, the Shore D values for the present polyolefin composition are equal to or less than 52, alternatively from 52 to 30.

In some embodiments, the tensile elongation at break for the present polyolefin composition, measured according to ISO 527, is equal to or greater than 135%, alternatively equal to or greater than 200%, alternatively the upper limit being 700%.

In some embodiments, the butene-1 copolymer component A), immediately after being melted and cooled, does not show a melting peak at the second heating scan. In some embodiments, the butene-1 copolymer is crystallizable. About 10 days after being melted, the polymer shows a measurable melting point and a melting enthalpy measured by Differential Scanning calorimetry (DSC). In other words, the butene-1 copolymer shows no melting temperature attributable to polybutene-1 crystallinity (TmII) DSc, measured after cancelling the thermal history of the sample.

In some embodiments, the butene-1 copolymer component A) has at least one of the following additional features:
a MIE of from 0.5 to 3 g/10 min., alternatively from 0.8 to 3 g/10 min;
a lower limit of the copolymerized ethylene content of 12% by mole, based upon the molar composition of the copolymer;
a Shore A value equal to or less than 80, alternatively equal to or less than 65, alternatively from 80 to 40, alternatively from 65 to 40;
a Shore D value equal to or less than 20, alternatively from 20 to 5;
a Mw/Mn value, where Mw is the weight average molar mass and Mn is the number average molar mass, both measured by Gel Permeation Chromatography (GPC), equal to or less than 3, alternatively from 3 to 1.5;
a percentage of butene-1 units in the form of isotactic pentads (mmmm %) greater than 80%, alternatively equal to or greater than 85%, alternatively equal to or greater than 90%, wherein the upper limit is 99%;
a tensile stress at break, measured according to ISO 527, of from 3 MPa to 20 MPa, alternatively from 4 MPa to 13 MPa;
a tensile elongation at break, measured according to ISO 527, of from 550% to 1000%; alternatively from 700% to 1000%;
an intrinsic viscosity (I.V.) equal to or greater than 1 dl/g; alternatively equal to or greater than 1.5 dl/g, wherein the upper limit is of 3 dl/g;
a crystallinity of less than 30% measured via X-ray, alternatively of less than 20%;
a density of 0.895 g/cm³ or less, alternatively of 0.875 g/cm³ or less; wherein the lower limit is of 0.86 g/cm³; and
a content of xylene insoluble fraction at 0° C. of less than 15% by weight, wherein the lower limit is 0%; and
a Flexural Elastic Modulus equal to or less than 20 MPa, alternatively the lower limit being 5 MPa.

In some embodiments, the butene-1 copolymer component A) is obtained by polymerizing the monomer(s) in the presence of a metallocene catalyst system obtainable by contacting:
a stereorigid metallocene compound;
an alumoxane or a compound capable of forming an alkyl metallocene cation; and, optionally,
an organo aluminum compound.

In some embodiments, the stereorigid metallocene compound belongs to the following formula (I):

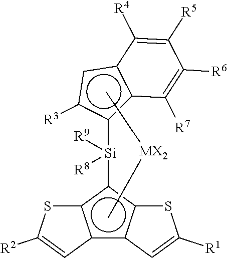

wherein:
M is an atom of a transition metal selected from Group 4 of the Periodic Table of Elements; alternatively M is zirconium;
X, equal to or different from each other, is a hydrogen atom, a halogen atom, a R, OR, OR′O, OSO₂CF₃, OCOR, SR, NR₂ or PR₂ group wherein R is a linear or branched, saturated or unsaturated C₁-C₂₀-alkyl, C₃-C₂₀-cycloalkyl, C₆-C₂₀-aryl, C₇-C₂₀-alkylaryl or C₇-C₂₀-arylalkyl radical, optionally containing heteroatoms belonging to Groups 13-17 of the Periodic Table of the Elements; and R′ is a C₁-C₂₀-alkylidene, C₆-C₂₀-arylidene, C₇-C₂₀-alkylarylidene, or C₇-C₂₀-arylalkylidene radical;
R¹, R², R⁵, R⁶, R⁷, R⁸ and R⁹, equal to or different from each other, are hydrogen atoms, or linear or branched, saturated or unsaturated C₁-C₂₀-alkyl, C₃-C₂₀-cycloalkyl, C₆-C₂₀-aryl, C₇-C₂₀-alkylaryl or C₇-C₂₀-arylalkyl radicals, optionally containing heteroatoms belonging to Groups 13-17 of the Periodic Table of the Elements; alternatively R⁵ and R⁶, or R⁸ and R⁹ form a saturated or unsaturated, 5 or 6 membered rings; providing that at least one of R⁶ or R⁷ is a linear or branched, saturated or unsaturated C₁-C₂₀-alkyl radical, optionally containing heteroatoms belonging to Groups 13-17 of the Periodic Table of the Elements;
R³ and R⁴, equal to or different from each other, are linear or branched, saturated or unsaturated C₁-C₂₀-alkyl radicals, optionally containing heteroatoms belonging to Groups 13-17 of the Periodic Table of the Elements.
In some embodiments, X is a hydrogen atom, a halogen atom, a OR′O or R group. In some embodiments, X is chlorine or a methyl radical. In some embodiments, the R⁵-R⁶ or R⁸-R⁹ ring bears C₁-C₂₀ alkyl radicals as substituents. In some embodiments, R⁶ or R⁷ is a C₁-C₁₀-alkyl radical. In some embodiments, R³ and R⁴, equal to or different from each other, are C₁-C₁₀-alkyl radicals. In some embodiments, R³ is a methyl or ethyl radical. In some embodiments, R⁴ is a methyl, ethyl, or isopropyl radical.

In some embodiments, the compounds of formula (I) have the formula (Ia):

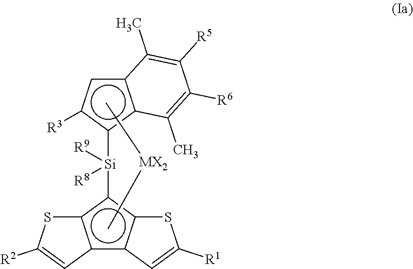

### Wherein:

M, X, R¹, R², R⁵, R⁶, R⁸ and R⁹ are as described above;
R³ is a linear or branched, saturated or unsaturated C₁-Cao-alkyl radical, optionally containing heteroatoms belonging to groups 13-17 of the Periodic Table of the Elements; alternatively R³ is a C₁-C₁₀-alkyl radical; alternatively R³ is a methyl or ethyl radical.

In some embodiments, the metallocene compounds are selected from the group consisting of dimethylsilanediyl {(1-(2,4,7-trimethylindenyl)-7-(2,5-dimethyl-cyclopenta[1,2-b: 4,3-b′]-dithiophene)}Zirconium dichloride and dimethylsilanediyl{(1-(2,4,7-trimethylindenyl)-7-(2,5-dimethyl-cyclopenta[1,2-b:4,3-b’]-dithiophene)}Zirconium dimethyl.

In some embodiments, the alumoxanes are selected from the group consisting of methylalumoxane (MAO), tetra-(isobutyl)alumoxane (TIBAO), tetra-(2,4,4-trimethyl-pentyl)alumoxane (TIOAO), tetra-(2,3-dimethylbutyl)alumoxane (TDMBAO), and tetra-(2,3,3-trimethylbutyl)alumoxane (TTMBAO).

In some embodiments, the alkylmetallocene cation is prepared from compounds of formula D⁺E⁻, wherein D⁺ is a Brønsted acid, able to donate a proton and to react irreversibly with a substituent X of the metallocene of formula (I), and E is a compatible anion, which is able to stabilize the active catalytic species originating from the reaction of the two compounds, and which is able to be removed by an olefinic monomer. In some embodiments, the anion E is made from or containing one or more boron atoms.

In some embodiments, the organo-aluminum compounds are selected from the group consisting of trimethylaluminum (TMA), triisobutylaluminium (TIBAL), tris(2,4,4-trimethyl-pentyl)aluminum (TIOA), tris(2,3-dimethylbutyl)aluminum (TDMBA), and tris(2,3,3-trimethylbutyl)aluminum (TTMBA).

In some embodiments, the catalyst system and the polymerization processes employing such catalyst system are as described in Patent Cooperation Treaty Publication Nos. WO2004099269 and WO2009000637.

In some embodiments, the polymerization process for the preparation of the butene-1 copolymer component A) is carried out via slurry polymerization using as diluent a liquid inert hydrocarbon. In some embodiments, the polymerization process for the preparation of the butene-1 copolymer component A) is carried out via solution polymerization. In some embodiments, liquid butene-1 is used as a reaction medium. In some embodiments, the polymerization process occurs in the gas-phase, operating in one or more fluidized bed or mechanically agitated reactors.

In some embodiments, the polymerization temperature is from −100° C. to 200° C., alternatively from 20° C. to 120° C., alternatively from 40° C. to 90° C., alternatively from 50° C. to 80° C.

In some embodiments, the polymerization pressure is between 0.5 bar and 100 bar. In some embodiments, the polymerization is carried out in one or more reactors that work under same or different reaction conditions such as concentration of molecular weight regulator, comonomer concentration, temperature, and pressure.

In some embodiments, flame-retardant inorganic fillers B) are selected from the group consisting of oxides, hydroxides, hydrated oxides, salts, and hydrated salts of metals. In some embodiments, the metals are selected from the group consisting of Ca, Al, and Mg. In some embodiments, the flame-retardant inorganic fillers B) are selected from the group consisting of magnesium hydroxide Mg(OH)₂, aluminum hydroxide Al(OH)₃, alumina trihydrate Al₂O₃·3H₂O, magnesium carbonate hydrate, magnesium carbonate MgCO₃, magnesium calcium carbonate hydrate, magnesium calcium carbonate, and mixtures thereof.

In some embodiments, the flame-retardant inorganic fillers B) are selected from the group consisting of Mg(OH)₂, Al(OH)₃, Al₂O₃·3H₂O, and mixtures thereof.

In some embodiments, the metal hydroxides are used in the form of particles with sizes ranging between 0.1 and 100 μm, alternatively between 0.5 and 10 μm. In some embodiments, the metal hydroxides are selected from the group consisting of the magnesium hydroxides and aluminum hydroxides.

In some embodiments, the inorganic is a precipitated magnesium hydroxide, having specific surface area of from 1 to 20 m²/g, alternatively from 3 to 10 m²/g, and an average particle diameter ranging from 0.5 to 15 μm, alternatively from 0.6 to 1 μm.

In some embodiments, the precipitated magnesium hydroxide contains low amounts of impurities deriving from salts, oxides, or hydroxides of other metals. In some embodiments, the other metals are selected from the group consisting of Fe, Mn, Ca, Si, and V. In some embodiments, the amount and nature of the impurities depend on the origin of the starting material. In some embodiments, the degree of purity of the precipitated magnesium hydroxide is between 90 and 99% by weight.

In some embodiments, the filler is used in the form of coated particles. In some embodiments, the coating materials are saturated or unsaturated fatty acids containing from 8 to 24 carbon atoms, and metal salts thereof. In some embodiments, the coating materials are selected from the group consisting of oleic acid, palmitic acid, stearic acid, isostearic acid, and lauric acid, and magnesium or zinc stearate or oleate.

In some embodiments, inorganic oxides or salts are selected from the group consisting of CaO, TiO₂, Sb₂O₃, ZnO, Fe₂O₃, CaCO₃, BaSO₄, and mixtures thereof.

In some embodiments, the polyolefin b) is selected from the following polymers and polymer compositions
1) propylene homopolymers;
2) copolymers of propylene with one or more comonomers selected from ethylene and C₄-C₁₀ alpha-olefins, wherein the comonomer content ranges from 0.05% to 20% by weight with respect to the total weight of the copolymer, or mixtures of the copolymers with propylene homopolymers 1);
3) heterophasic polyolefin compositions made from or containing

i) a propylene homopolymer 1) or a copolymer 2), and

ii) an elastomeric fraction made from or containing copolymers of ethylene with propylene or a C₄-C₁₀ alpha-olefin, optionally containing minor amounts of a diene, such as butadiene, 1,4-hexadiene, 1,5-hexadiene, ethylidene-1-norbornene.

In some embodiments, the C₄-C₁₀ alpha-olefins are selected from olefins having formula CH₂=CHR wherein R is an alkyl radical, linear or branched, or an aryl radical, having from 2 to 8 carbon atoms.

In some embodiments, the C₄-C₁₀ alpha-olefins are selected from the group consisting of butene-1, pentene-1, 4-methylpentene-1, hexene-1, and octene-1.

In some embodiments, the comonomers are selected from the group consisting of ethylene, butene-1, and hexene-1.

In some embodiments, the propylene homopolymers 1) are crystalline homopolymers, having a stereoregularity of isotactic type.

In some embodiments, the propylene homopolymers 1) have a content of fraction soluble in xylene at 25° C. of 10% by weight or less, alternatively from 10% to 0.5% by weight, alternatively from 10% to 1% by weight, referred to the total weight of the propylene homopolymer.

In some embodiments, the propylene copolymers 2) are crystalline, random copolymers, having a stereoregularity of isotactic type.

In some embodiments, the propylene copolymers 2) have a content of fraction soluble in xylene at 25° C. of 15% by weight or less, alternatively from 15% to 5% by weight, referred to the total weight of the propylene copolymer.

In some embodiments, the propylene homopolymers 1) and the propylene copolymers 2) have MIL values of from 0.5 to 100 g/10 min, alternatively from 1 to 50 g/10 min., where MIL is the melt flow index at 230° C. with a load of 2.16 kg, determined according to ISO 1133-2:2011.

In some embodiments, the propylene homopolymers 1) and the propylene copolymers 2) are commercially available.

In some embodiments, the commercially available homopolymers and copolymers of propylene are polymer products sold by the LyondellBasell Industries under the trademark Moplen.

In some embodiments, the propylene homopolymers 1) and the propylene copolymers 2) are prepared by using a Ziegler-Natta catalyst or a metallocene-based catalyst system in the polymerization process.

In some embodiments, a Ziegler-Natta catalyst is made from or containing the product of the reaction of an organometallic compound of group 1, 2 or 13 of the Periodic Table of elements with a transition metal compound of groups 4 to 10 of the Periodic Table of Elements (new notation). In some embodiments, the transition metal compound is selected from the group consisting of compounds of Ti, V, Zr, Cr and Hf. In some embodiments, the transition metal is supported on MgCl₂.

In some embodiments, catalysts are made from or containing the product of the reaction of the organometallic compound of group 1, 2 or 13 of the Periodic Table of elements, with a solid catalyst component made from or containing a Ti compound and an electron donor compound supported on MgCl₂.

In some embodiments, the organometallic compounds are aluminum alkyl compounds.

In some embodiments, the Ziegler-Natta catalysts are made from or containing the product of reaction of:
1) a solid catalyst component made from or containing a Ti compound, alternatively a halogenated Ti compound, alternatively TiCl₄, and an electron donor (internal electron-donor) supported on MgCl₂;
2) an aluminum alkyl compound (cocatalyst); and, optionally,
3) an electron-donor compound (external electron-donor).

In some embodiments, the solid catalyst component (1) contains, as an electron-donor, a compound selected from the group consisting of ethers, ketones, lactones, compounds containing N, P and/or S atoms, and mono- and dicarboxylic acid esters.

In some embodiments, the catalysts are as described in U.S. Pat. No. 4,399,054 and European Patent No. 45977.

In some embodiments, the electron-donor compounds are selected from the group consisting of phthalic acid esters and succinic acid esters. In some embodiments, the phthalic acid ester is diisobutyl phthalate.

In some embodiments, the electron-donors are the 1,3-diethers described in European Patent Application Nos. EP-A-361 493 and 728769.

In some embodiments, cocatalysts (2) are trialkyl aluminum compounds. In some embodiments, the trialkyl aluminum compounds are selected from the group consisting of Al-triethyl, Al-triisobutyl, and Al-tri-n-butyl.

In some embodiments, the electron-donor compounds (3) used as external electron-donors (added to the Al-alkyl compound) are selected from the group consisting of aromatic acid esters, heterocyclic, and silicon compounds containing at least one Si—OR bond (where R is a hydrocarbon radical). In some embodiments, the aromatic acid esters are alkylic benzoates. In some embodiments, the heterocyclic compounds are selected from the group consisting of 2,2,6,6-tetramethylpiperidine and 2,6-diisopropylpiperidine.

In some embodiments, the silicon compounds have the formula R¹ₐR²_{b}Si(OR³)_{c}, where a and b are integer numbers from 0 to 2, c is an integer from 1 to 3, and the sum (a+b+c) is 4; R¹, R² and R³ are alkyl, cycloalkyl or aryl radicals with 1-18 carbon atoms optionally containing heteroatoms.

In some embodiments, the silicon compounds are selected from the group consisting of (tert-butyl)₂Si(OCH₃)₂, (cyclohexyl)(methyl)Si(OCH₃)₂, (phenyl)₂Si(OCH₃)₂, and (cyclopentyl)₂Si(OCH₃)₂.

In some embodiments, the 1,3-diethers are used as external donors. In some embodiments, the internal donor is a 1,3-diethers and the external donor is omitted.

In some embodiments, the catalysts are precontacted with small quantities of olefin (prepolymerization), maintaining the catalyst in suspension in a hydrocarbon solvent, and polymerizing at temperatures from room to 60° C., thereby producing a quantity of polymer from 0.5 to 3 times the weight of the catalyst.

In some embodiments, the operation takes place in liquid monomer, producing a quantity of polymer up to 1000 times the weight of the catalyst.

In some embodiments, the polymerization process is a continuous process. In some embodiments, the polymerization is a batch process. In some embodiments, the polymerization is carried out in the presence of the catalysts in liquid phase, in the presence or not of inert diluent, or in gas phase, or by mixed liquid-gas techniques.

In some embodiments, the temperature for the polymerization steps is from 20 to 100° C. In some embodiments, the pressure for the polymerization steps is atmospheric or higher.

In some embodiments, the molecular weight is regulated. In some embodiments, the molecular weight regulator is hydrogen.

In some embodiments, the metallocene-based catalyst systems are as described in United States Patent Application Publication No. US20060020096 and Patent Cooperation Treaty Publication No. WO98040419.

In some embodiments, the polymerization conditions for preparing the homopolymers or copolymers of propylene with metallocene-based catalyst systems are the same as polymerization conditions used with Ziegler-Natta catalysts.

In some embodiments, the heterophasic polyolefin composition 3) is made from or containing:

ii) one or more propylene polymers selected from propylene homopolymers 1) or copolymers of propylene 2) as previously defined, or combinations thereof, and

ii) a copolymer or a composition of copolymers of ethylene with propylene or a C₄-C₁₀ alpha-olefin and optionally with minor amounts of a diene, wherein the copolymer or composition containing 15% by weight or more, alternatively from 15% to 90% by weight, alternatively from 25 to 85% by weight, of ethylene with respect to the weight of ii). In some embodiments, the diene is present in an amount from 1 to 10% by weight with respect to the weight of ii).

In some embodiments, the heterophasic polyolefin composition are made from or containing from 40 to 90% by weight of component i) and 10 to 60% by weight of component ii), referred to the total weight of i)+ii).

In some embodiments, the heterophasic composition has a MIL ranging from 0.1 to 50 g/10 minutes, alternatively from 0.5 to 20 g/10 minutes.

In some embodiments, the elongation at break of the heterophasic composition is from 100% to 1000%.

In some embodiments, the flexural modulus of the heterophasic composition is from 500 to 1500 MPa, alternatively from 700 to 1500 MPa.

In some embodiments, the copolymer or composition of copolymers (ii) has a solubility in xylene at 25° C. of from 40% to 100% by weight, alternatively from 50% to 100% by weight, referred to the total weight of (ii).

In some embodiments, the heterophasic compositions are commercially available.

In some embodiments, the commercially available heterophasic compositions are polymer products sold by the LyondellBasell Industries under the trademark Moplen.

In some embodiments, the heterophasic polyolefin composition 3) is prepared by blending components (i) and (ii) in the molten state, that is, at temperatures greater than the components' softening or melting point, alternatively by sequential polymerization in the presence of a highly stereospecific Ziegler-Natta catalyst.

In some embodiments, the catalysts are metallocene-type catalysts, as described in U.S. Pat. No. 5,324,800 and European Patent Application No. EP-A-0 129 368, alternatively are bridged bis-indenyl metallocenes. In some embodiments, the metallocene catalysts are as described in U.S. Pat. No. 5,145,819 and European Patent Application No. EP-A-0 485 823. In some embodiments, the metallocene catalysts are used to prepare the component (ii). In some embodiments, the sequential polymerization process for the production of the heterophasic composition includes at least two stages, where, in one or more stage(s), propylene is polymerized, optionally in the presence of the C₄-C₁₀ alpha-olefin comonomer(s), to form component (i), and, in one or more additional stage(s), mixtures of ethylene with propylene or a C₄-C₁₀ alpha-olefin, and optionally diene, are polymerized to form component (ii).

In some embodiments, the polymerization processes are carried out in liquid, gaseous, or liquid/gas phase. In some embodiments, the reaction temperature in the various stages of polymerization is equal or different. In some embodiments, the reaction temperature for preparing component (i) ranges from 40 to 90° C., alternatively from 50 to 80° C. In some embodiments, the reaction temperature for preparing component (ii) ranges from 40 to 60° C. In some embodiments, the sequential polymerization processes are as described in European Patent Application Nos. EP-A-472946 and EP-A-400333 and Patent Cooperation Treaty Publication No. WO03/011962.

In some embodiments, a coupling agent c) is added in the present polyolefin composition, thereby enhancing the compatibility between the inorganic filler and the polymer components.

In some embodiments, the coupling agents are made from or containing saturated silane compounds or silane compounds containing at least one ethylenic unsaturation, epoxides containing an ethylenic unsaturation, organic titanates, mono- or dicarboxylic acids containing at least one ethylenic unsaturation, or derivatives thereof such as anhydrides or esters.

In some embodiments, the coupling agents c) are homopolymers and copolymers of alpha-olefins containing polar groups. In some embodiments, the polar groups are carboxyl, hydroxyl, or ester groups. In some embodiments, the coupling agents c) are butene-1 homopolymers, copolymers of butene-1 with an alpha-olefin, ethylene homopolymers, or copolymers of ethylene with an alpha-olefin.

In some embodiments, the coupling agents are obtained by grafting mono- or dicarboxylic acids containing at least one ethylenic unsaturation, or derivatives thereof (on the homopolymers and copolymers of alpha-olefins. In some embodiments, the acids are selected from the group consisting of maleic acid, fumaric acid, citraconic acid, itaconic acid, acrylic acid, and methacrylic acid. In some embodiments, the derivatives are anhydrides or esters derived therefrom.

In some embodiments, the coupling agents are selected from the group consisting of homopolymers and copolymers of alpha-olefins grafted with maleic anhydride.

In some embodiments, grafting is achieved by a radical reaction. In some embodiments, the radical reaction is as described in European Patent Application No. EP-A-530 940.

In some embodiments, the amount of coupling agent c) is 0.1% to 10% by weight, referred to the total weight of a)+b)+c).

In some embodiments, the present polyolefin composition is prepared by mixing the polymer components, the filler, and the other optional components in an internal mixer having tangential rotors (such as Banbury mixers) or interpenetrating rotors, alternatively in continuous mixers (such as Buss mixers) or co-rotating or counter-rotating twin-screw extruders.

In some embodiments, the mixing or extrusion temperatures are from 160° C. to 220° C.

In some embodiments, the present polyolefin composition is used in electrical wires and cables covering, reinforced and non-reinforced roofing membranes, and adhesive tapes. In some embodiments, the present polyolefin composition is used as an inner filling for industrial cables. In some embodiments, the polyolefin composition is an insulating layer of electrically conductive wires and cables.

In some embodiments, the present polyolefin composition is used in non-flame-retardant soft membranes, coupled or non-coupled with a reinforcement, and as synthetic leather. In some embodiments, the present polyolefin composition is used in non-flame-retardant soft membranes in publicity banners, liners, tarpaulin, and sport-wear and safety clothing.

In some embodiments, the present polyolefin composition is used in packaging and extrusion coating.

In some embodiments, the present polyolefin composition is further made from or containing additives.

In some embodiments, the present polyolefin composition is used in combination with elastomeric polymers such as ethylene/propylene copolymers (EPR), ethylene/propylene/diene terpolymers (EPDM), copolymers of ethylene with C₄-C₁₂ alpha-olefins, and mixtures thereof. In some embodiments, the copolymers of ethylene with C₄-C₁₂ alpha-olefins are ethylene/octene-1 copolymers. In some embodiments, the copolymers of ethylene with C₄-C₁₂ alpha-olefins are commercialized under the tradename Engage.

In some embodiments, the additives are selected from the group consisting of processing aids, lubricants, nucleating agents, extension oils, organic and inorganic pigments, anti-oxidants, and UV-protectors.

In some embodiments, the processing aids are selected from the group consisting of calcium stearate, zinc stearate, stearic acid, paraffin wax, synthetic oil, and silicone rubbers.

In some embodiments, the antioxidants are selected from the group consisting of pentaerythritol tetrakis(3-(3,5-di-tert-butyl-4-hydroxyphenyl)propionate and 1,2-bis(3,5-di-tert-butyl-4-hydroxyhydrocinnamoyl)hydrazine.

In some embodiments, the present polyolefin composition is further made from or containing other fillers selected from the group consisting of glass particles, glass fibers, calcinated kaolin, and talc.

### EXAMPLES

The following examples are given to illustrate, not limit the scope of the present disclosure in any manner whatsoever.

The following analytical methods are used to characterize the polymer compositions.

Thermal properties (melting temperatures and enthalpies)

Determined by Differential Scanning calorimetry (DSC) on a Perkin Elmer DSC-7 instrument.

The melting temperature (TmII) of the butene-1 copolymer A) was determined according to the following method:
TmII (measured in second heating scan): a weighed sample (5-10 mg) was sealed into aluminum pans and heated at 200° C. with a scanning speed corresponding to 10° C./minute. The sample was kept at 200° C. for 5 minutes, thereby allowing complete melting of the crystallites and cancelling the thermal history of the sample. Successively, after cooling to −20° C. with a scanning speed corresponding to 10° C./minute, the peak temperature was taken as crystallization temperature (T_{c}). After standing 5 minutes at −20° C., the sample was heated for the second time to 200° C. with a scanning speed corresponding to 10° C./min. In this second heating run, the peak temperature, when present, was taken as the melting temperature of the polybutene-1 (PB) crystalline form II (TmII) and the area as the global melting enthalpy (4HM).

The butene-1 copolymer component A) of the polyolefin composition does not have a TmII peak.

MIE

Determined according to norm ISO 1133-2:2011 with a load of 2.16 kg at 190° C.

MIL

Determined according to norm ISO 1133-2:2011 with a load of 2.16 kg at 230° C.

Flexural Elastic Modulus

According to norm ISO 178:2019, measured 10 days after molding.

Tensile Elastic Modulus (MET-DMTA)

Determined at 23° C. via DMTA analysis according to ISO 6721-4:2019 on 1 mm thick compression molded plaque.

Shore A and D

According to norm ISO 868:2003, measured 10 days after molding.

Tensile Stress and Elongation at Break

According to norm ISO 527-1:2019 on compression molded plaques, measured 10 days after molding.

Intrinsic Viscosity

Determined according to norm ASTM D 2857-16 in tetrahydronaphthalene at 135° C.

Density

Determined according to norm ISO 1183-1:2019 at 23° C.

Comonomer Contents

Determined by IR spectroscopy or by NMR.

For the butene-1 copolymers, the amount of comonomer was calculated from the ¹³C-NMR spectra of the copolymers. Measurements were performed on a polymer solution (8-12 wt %) in dideuterated 1,1,2,2-tetrachloro-ethane at 120° C. The ¹³C NMR spectra were acquired on a Bruker AV-600 spectrometer operating at 150.91 MHz in the Fourier transform mode at 120° C. using a 90° pulse, 15 seconds of delay between pulses and CPD (WALTZ16), thereby removing 41-¹³C coupling. About 1500 transients were stored in 32K data points using a spectral window of 60 ppm (0-60 ppm).

Copolymer Composition

Diad distribution was calculated from ¹³C NMR spectra using the following relations:
PP=100 I₁/Σ
PB=100 I₂/Σ
BB=100 (I₃−I₁₉)/Σ
PE=100 (I₅+I₆)/Σ
BE=100 (I₉+I₁₀)/Σ
EE=100 (0.5(I₁₅+I₆+I₁₀)+0.25 (I₁₄))/Σ
where Σ=I₁+I₂+I₃−I₁₉+I₅+I₆+I₉+I₁₀+0.5(I₁₅+I₆+I₁₀+0.25 (I₁₄)
The molar content was obtained from the diads using the following relations:
P (m %)=PP+0.5 (PE+PB)
B (m %)=BB+0.5 (BE+PB)
E (m %)=EE+0.5 (PE+BE)

I₁, I₂, I₃, I₅, I₆, I₉, I₆, I₁₀, I₁₄, I₁₅, I₁₉ are integrals of the peaks in the ¹³C NMR spectrum (peak of EEE sequence at 29.9 ppm as reference). The assignments of these peaks were made according to J. C. Randali, Macromol. Chem Phys., C29, 201 (1989), M. Kakugo, Y. Naito, K. Mizunuma and T. Miyatake, Macromolecules, 15, 1150, (1982), and H. N. Cheng, Journal of Polymer Science, Polymer Physics Edition, 21, 57 (1983). The results were collected in Table A (nomenclature according to C. J. Carman, R. A. Harrington and C. E. Wilkes, Macromolecules, 10, 536 (1977)).

TABLE A

| I | Chemical Shift (ppm) | Carbon | Sequence |
|---|---|---|---|
| 1 | 47.34-45.60 | S_{αα} | PP |
| 2 | 44.07-42.15 | S_{αα} | PB |
| 3 | 40.10-39.12 | S_{αα} | BB |
| 4 | 39.59 | T_{δδ} | EBE |
| 5 | 38.66-37.66 | S_{αγ} | PEP |
| 6 | 37.66-37.32 | S_{αδ} | PEE |
| 7 | 37.24 | T_{βδ} | BBE |
| 8 | 35.22-34.85 | T_{ββ} | XBX |
| 9 | 34.85.34.49 | S_{αγ} | BBE |
| 10 | 34.49-34.00 | S_{αδ} | BEE |
| 11 | 33.17 | T_{δδ} | EPE |
| 12 | 30.91-30.82 | T_{βδ} | XPE |
| 13 | 30.78-30.62 | S_{γγ} | XEEX |
| 14 | 30.52-30.14 | S_{γβ} | XEEE |
| 15 | 29.87 | S_{δδ} | EEE |
| 16 | 28.76 | T_{ββ} | XPX |
| 17 | 28.28-27.54 | 2B₂ | XBX |
| 18 | 27.54-26.81 | S_{βδ} + 2B₂ | BE, PE, BBE |
| 19 | 26.67 | 2B₂ | EBE |
| 20 | 24.64-24.14 | S_{ββ} | XEX |
| 21 | 21.80-19.50 | CH₃ | P |
| 22 | 11.01-10.79 | CH₃ | B |

For the propylene copolymers, the comonomer content was determined by infrared spectroscopy by collecting the IR spectrum of the sample vs. an air background with a Fourier Transform Infrared spectrometer (FTIR). The instrument data acquisition parameters were:
purge time: 30 seconds minimum;
collect time: 3 minutes minimum;
apodization: Happ-Genzel;
resolution: 2 cm⁻¹.

Sample Preparation

Using a hydraulic press, a thick sheet was obtained by pressing about 1 gram of sample between two aluminum foils. If homogeneity was uncertain, a minimum of two pressing operations occurred. A small portion was cut from this sheet to mold a film. The film thickness was between 0.02-:0.05 cm (8-20 mils).

Pressing temperature was 180±10° C. (356° F.) at about 10 kg/cm² (142.2 PSI) pressure for about one minute. Then the pressure was released, and the sample was removed from the press and cooled to room temperature.

The spectrum of a pressed film of the polymer was recorded in absorbance vs. wavenumbers (cm⁻¹). The following measurements were used to calculate ethylene and butene-1 content:
Area (At) of the combination absorption bands between 4482 and 3950 cm⁻¹ which was used for spectrometric normalization of film thickness.
If ethylene was present, Area (AC2) of the absorption band between 750-700 cm⁻¹ after two proper consecutive spectroscopic subtractions of an isotactic non additivated polypropylene spectrum was measured and then, if butene-1 was present, a reference spectrum of a butene-1-propylene random copolymer in the range 800-690 cm⁻¹ was used.
If butene-1 was present, the height (DC4) of the absorption band at 769 cm⁻¹ (maximum value), after two proper consecutive spectroscopic subtractions of an isotactic non additivated polypropylene spectrum was measured and then, if ethylene was present, a reference spectrum of an ethylene-propylene random copolymer in the range 800-690 cm⁻¹ was used.
   To calculate the ethylene and butene-1 content, calibration straight lines for ethylene and butene-1 were obtained by using reference samples of ethylene and butene-1.

Mw/Mn Determination by GPC

The determination of the means Mn and Mw, and Mw/Mn derived therefrom was carried out using a Waters GPCV 2000 apparatus, which was equipped with a column set of four PLgel Olexis mixed-gel (Polymer Laboratories) and an IR4 infrared detector (PolymerChar). The dimensions of the columns were 300×7.5 mm, and the particle size was 13 pm. The mobile phase used was 1-2-4-trichlorobenzene (TCB). The flow rate was kept at 1.0 ml/min. The measurements were carried out at 150° C. Solution concentrations were 0.1 g/dl in TCB, and 0.1 g/l of 2,6-diterbuthyl-p-chresole was added to prevent degradation. For GPC calculation, a universal calibration curve was obtained using 10 polystyrene (PS) standard samples supplied by Polymer Laboratories (peak molecular weights ranging from 580 to 8500000). A third order polynomial fit was used to interpolate the experimental data and obtain the relevant calibration curve. Data acquisition and processing were done using Empower (Waters). The Mark-Houwink relationship was used to determine the molecular weight distribution and the relevant average molecular weights: the K values were K_{PS}=1.21×10⁻⁴ dL/g and K_{PB}=1.78×10⁻⁴ dL/g for PS and PB respectively, while the Mark-Houwink exponents α=0.706 for PS and α=0.725 for PB were used.

For butene-1/ethylene copolymers, the composition was assumed constant in the whole range of molecular weight, and the K value of the Mark-Houwink relationship was calculated using a linear combination:

K_{EB}=x_{E}K_{PE}+xₚK_{PB},

where K_{EB} was the constant of the copolymer, K_{PE} (4.06×10⁻⁴, dL/g) and K_{PB} (1.78×10⁻⁴ dl/g) were the constants of polyethylene and polybutene and X_{E} and X_{B} were the ethylene and the butene-1 weight % content, based upon the weight of the total copolymer. The Mark-Houwink exponents α=0.725 was used for the butene-1/ethylene copolymers.

Fractions Soluble and Insoluble in Xylene at 0° C. (XS-0° C.)

2.5 g of the polymer sample were dissolved in 250 ml of xylene at 135° C. under agitation. After 30 minutes, the solution was allowed to cool to 100° C., under agitation, and then placed in a water and ice bath to cool down to 0° C. Then, the solution was allowed to settle for 1 hour in the water and ice bath. The precipitate was filtered with filter paper. During the filtering, the flask was left in the water and ice bath, thereby keeping the flask inner temperature as near to 0° C. as possible. Once the filtering was finished, the filtrate temperature was balanced at 25° C., dipping the volumetric flask in a water-flowing bath for about 30 minutes. Then, the flask contents were divided in two 50 ml aliquots. The solution aliquots were evaporated in nitrogen flow, and the residue was dried under vacuum at 80° C. until a constant weight was reached. If the weight difference between the two residues was less than 3%, the test was terminated. If the weight difference between the two residues was not less than 3%, the test was repeated. The percent by weight of polymer soluble (Xylene Solubles at 0° C.=XS 0° C.) was calculated from the average weight of the residues. The insoluble fraction in o-xylene at 0° C. (xylene Insolubles at 0° C.=XI %0° C.) was:

XI %0° C.=100−XS %0° C.

Fractions Soluble and Insoluble in Xylene at 25° C. (XS-25° C.)

2.5 g of polymer were dissolved in 250 ml of xylene at 135° C. under agitation. After 20 minutes, the solution was allowed to cool to 25° C., under agitation, and then allowed to settle for 30 minutes. The precipitate was filtered with filter paper. The solution was evaporated in nitrogen flow. The residue was dried under vacuum at 80° C. until constant weight was reached. The percent by weight of polymer soluble (Xylene Solubles—XS) and insoluble at room temperature (25° C.) were calculated.

As used herein, the percent by weight of polymer insoluble in xylene at room temperature (25° C.) was considered the isotactic index of the polymer. It is believed that this measurement corresponds to the isotactic index determined by extraction with boiling n-heptane, which constitutes the isotactic index of polypropylene polymers.

Determination of Isotactic Pentads Content

50 mg of each sample were dissolved in 0.5 ml of C₂D₂Cl₄.

The ¹³C NMR spectra were acquired on a Bruker DPX-400 (100.61 Mhz, 90° pulse, 12s delay between pulses). About 3000 transients were stored for each spectrum; the mmmm pentad peak (27.73 ppm) was used as the reference.

The microstructure analysis was carried out as described in the literature (Macromolecules 1991, 24, 2334-2340, by Asakura T. et al. and Polymer, 1994, 35, 339, by Chujo R. et al.).

The percentage value of pentad tacticity (mmmm %) for butene-1 copolymers was the percentage of stereoregular pentads (isotactic pentad) as calculated from the relevant pentad signals (peak areas) in the NMR region of branched methylene carbons (around 27.73 ppm assigned to the BBBBB isotactic sequence), with due consideration of the superposition between stereoirregular pentads and signals, falling in the same region, due to the comonomer.

Determination of X-Ray Crystallinity

The X-ray crystallinity was measured with an X-ray Diffraction Powder Diffractometer using the Cu-Kα1 radiation with fixed slits and collecting spectra between diffraction angle 2Θ=5° and 2Θ=35° with step of 0.1° every 6 seconds.

Measurements were performed on compression-molded specimens in the form of disks of about 1.5-2.5 mm of thickness and 2.5-4.0 cm of diameter. These specimens were obtained in a compression-molding press at a temperature of 200° C.±5° C. without applying pressure for 10 minutes, then applying a pressure of about 10 kg/cm² for about a few second and repeating the last operation 3 times.

The diffraction pattern was used to derive the components for the degree of crystallinity by defining a linear baseline for the whole spectrum and calculating the total area (Ta), expressed in counts/sec·2Θ, between the spectrum profile and the baseline.

Then an amorphous profile was defined, along the whole spectrum, that separate, according to the two-phase model, the amorphous regions from the crystalline regions. The amorphous area (Aa), expressed in counts/sec·2Θ, was calculated as the area between the amorphous profile and the baseline. The crystalline area (Ca), expressed in counts/sec·2Θ, was calculated as Ca=Ta—Aa. The degree of crystallinity of the sample was then calculated according to the formula:

% Cr=100×Ca/Ta

### Examples 1-6 and Comparative Example 1

Materials Used in the Examples
PP: homopolymer of propylene having MTh of about 10 g/10 min., XS−25° C. of 2% by weight.
HECO: heterophasic polyolefin compositions having MTh of 0.8 g/10 min., flexural modulus of 1075 MPa and XS−25° C. of 18% by weight, made of:
   i) 83% by weight of a propylene homopolymer;
   ii) 17% by weight of a copolymer of propylene with ethylene, containing 40% by weight of ethylene.
ENGAGE: ethylene-octene copolymer plastomer having MIL of 0.5 g/10 min., was commercially available from Dow under trademark ENGAGE 8150.
PB-1: butene-1/ethylene copolymer containing 16% by moles of copolymerized ethylene, produced according to the process described in Patent Cooperation Treaty Publication No. WO2009000637 and in-line blended with a propylene copolymer composition (I) added in amount of 7% by weight with respect to the total weight of the butene-1/ethylene copolymer and the propylene copolymer composition (I).
   Such propylene copolymer composition (I) had MFRL of 5.5 g/10 min., total copolymerized ethylene content of 3% by weight, total copolymerized butene-1 content of 6% by weight; XS−25° C. of 19% by weight, and Tm of 133° C., and was made from or containing the following two components:
      I′) 35% by weight of a copolymer of propylene with ethylene (3.2% by weight in the copolymer), and
      I″) 65% by weight of a copolymer of propylene with ethylene (3.2% by weight in the copolymer) and butene-1 (6% by weight in the copolymer);
      wherein the amounts of I′) and I″) are referred to the total weight of I′)+I″).
   The copolymer composition (I) did not have a meaningful effect on the thermal and mechanical properties of the butene-1/ethylene copolymer.
   No melting peak was detected in the DSC analysis (second scan) of the PB-1.
   Table 1 reports properties of PB-1.
MDH: magnesium hydroxide having average particle size of 0.7-1.1 μm, purity 97-99%, was commercially available from Kyowa Chemical Industry under trademark Kisuma 5A.
C. Agent Coupling Agent, commercially available from BYK under trademark SCONA TSPB 5003 GA, was a butene-1 homopolymer grafted with maleic anhydride, containing about 1% by weight of maleic anhydride.
Stabilizer 1: pentaerythritol tetrakis (3-(3,5-di-tert-butyl-4-hydroxyphenyl)propionate, was commercially available from BASF under trademark Irganox 1010.
Stabilizer 2: metal deactivator and primary (phenolic) antioxidant containing 2′,3-bis [[3-[3,5-di-tert-butyl-4-hydroxyphenyl]propionyl]]propionohydrazide, was commercially available from BASF under trademark Irganox MD 1024.

The materials were melt-blended in a co-rotating twin screw extruder Leistritz Micro 27, with screw diameter of 27 mm and screw length/diameter ratio of 40 L/D, under the following conditions:
extruder barrel of 180-210° C.;
screw rotation speed of 250 rpm;
production rate of 15 kg/hour.

The amounts of the components and the properties of the final compositions are reported in Table 2.

TABLE I

| PB-1 | | |
|---|---|---|
| Tₘ II | ° C. | — |
| Δ H_{fus} | J/g | 0 |
| Shore A | | 60 |
| Shore D | | <20 |
| Flexural Elastic Modulus | MPa | <10 |
| MIE | g/10 min. | 1.4 |
| Tensile Strength at Break | MPa | 11 |
| Elongation at Break | % | 790 |

TABLE 2

| Example No. | | Comp. 1 | 1 | 2 | 3 | 4 | 5 | 6 |
|---|---|---|---|---|---|---|---|---|
| PP | % wt. | 6 | 6 | 8.7 | 6.9 | 5.1 | — | 3 |
| HECO | % wt. | — | — | — | — | — | 6 | — |
| ENGAGE | % wt. | 30 | — | — | — | — | — | — |
| PB-1 | % wt. | — | 30 | 43.3 | 34.4 | 25.6 | 30 | 33 |
| Amount of (A) | % wt. | — | 27.9 | 40.27 | 32 | 23.8 | 27.9 | 30.7 |
| Amount of (b) | % wt. | — | 8.1 | 11.73 | 9.3 | 6.9 | 8.1 | 5.3 |
| MDH | % wt. | 59.7 | 59.7 | 44.7 | 54.7 | 64.7 | 59.7 | 59.7 |
| (Component B)) | | | | | | | | |
| MDH/(A) | | — | 2.1 | 1.1 | 1.7 | 2.7 | 2.1 | 1.9 |
| MDH + (A) | % wt. | — | 87.6 | 85 | 86.7 | 88.5 | 87.6 | 90.4 |
| C. Agent | % wt. | 4 | 4 | 3 | 3.7 | 4.3 | 4 | 4 |
| Stabilizer 1 | % wt. | 0.15 | 0.15 | 0.15 | 0.15 | 0.15 | 0.15 | 0.15 |
| Stabilizer 2 | % wt. | 0.15 | 0.15 | 0.15 | 0.15 | 0.15 | 0.15 | 0.15 |
| Properties | | | | | | | | |
| Flexural Elastic | Mpa | 780 | 360 | 150 | 280 | 576 | 320 | 253 |
| Modulus | | | | | | | | |
| Tensile Strength | Mpa | 10 | 10.1 | 11 | 8.6 | 9.9 | 9.9 | 9.5 |
| at Break | | | | | | | | |
| Elongation at Break | % | 126 | 290 | 590 | 260 | 141 | 270 | 280 |
| Hardness Shore D | | 54.2 | 46.3 | 35.6 | 43.2 | 51.3 | 43.5 | 40.8 |
| MIE | g/10 min | 0.16 | 0.6 | 0.61 | 0.37 | <0.1 | 0.1 | 0.49 |
| MET at 23° C. | | 1070 | 480 | 205 | 395 | 730 | 440 | 405 |
| via DMTA | | | | | | | | |

Notes:
% weight = % by weight referred to the total weight of a) + b);
“C. Agent” = Coupling Agent.

1. A polyolefin composition comprising:
a) from 85% to 98% by weight of a composition comprising:
A) a copolymer of butene-1 with ethylene having a copolymerized ethylene content of up to 18% by mole and no melting peak detectable at the DSC at the second heating scan; and
B) an inorganic filler;
wherein the B)/A) weight ratio being from 0.3 to 4; and
b) from 2% to 15% by weight of an additional polyolefin different from A);
wherein the amounts of a) and b) refer to the total weight of a)+b) and the DSC second heating scan is carried out at a heating rate of 10° C. per minute.

2. The polyolefin composition of claim 1 containing 20% by weight or more of A) with respect to the total weight of the composition.

3. The polyolefin composition of claim 1 having a MIE equal to or greater than 0.05 g/10 min., where MIE is the melt flow index at 190° C. with a load of 2.16 kg, determined according to ISO 1133-2:2011.

4. The polyolefin composition of claim 1 having at least one of the following additional features:
a Flexural Elastic Modulus equal to or less than 600 MPa, measured according to norm ISO 178:2019, 10 days after molding;
a Shore D value equal to or less than 52; and
a tensile elongation at break, measured according to ISO 527-1:2019, equal to or greater than 135%.

5. The polyolefin composition of claim 1, wherein the butene-1 copolymer component A) has a Shore A value equal to or less than 80.

6. The polyolefin composition of claim 1, wherein the butene-1 copolymer component A) has at least one of the following additional features:
a MIE of from 0.5 to 3 g/10 min;
a lower limit of the copolymerized ethylene content of 12% by mole, based upon the molar composition of the copolymer;
a Shore D value equal to or less than 20;
a Mw/Mn value, where Mw is the weight average molar mass and Mn is the number average molar mass, both measured by GPC, equal to or less than 3;
a percentage of butene-1 units in form of isotactic pentads (mmmm %) greater than 80%;
a tensile stress at break, measured according to ISO 527, of from 3 MPa to 20 MPa;
a tensile elongation at break, measured according to ISO 527, of from 550% to 1000%;
an intrinsic viscosity (I.V.) equal to or greater than 1 dl/g;
a crystallinity of less than 30% measured via X-ray;
a density of 0.895 g/cm³ or less;
a content of xylene insoluble fraction at 0° C. of less than 15% by weight; and
a Flexural Elastic Modulus equal to or less than 20 MPa.

7. The polyolefin composition of claim 1, wherein component B) is selected from oxides, hydroxides, hydrated oxides, salts, hydrated salts of metals, and mixtures thereof.

8. The polyolefin composition of claim 7, wherein component B) is selected from the group consisting of CaO, TiO₂, Sb₂O₃, ZnO, Fe₂O₃, CaCO₃, BaSO₄, Mg(OH)₂, Al(OH)₃, Al₂O₃·3H₂O, magnesium carbonate hydrate, MgCO₃, magnesium calcium carbonate hydrate, magnesium calcium carbonate, and mixtures thereof.

9. The polyolefin composition of claim 1, wherein polyolefin b) is selected from:
1) propylene homopolymers;
2) copolymers of propylene with one or more comonomers selected from ethylene and C₄-C₁₀ alpha-olefins, wherein the comonomer content ranges from 0.05% to 20% by weight with respect to the total weight of the copolymer, or mixtures of the copolymers with propylene homopolymers 1);
3) heterophasic polyolefin compositions comprising
i) a propylene homopolymer 1) or a copolymer 2), and
ii) an elastomeric fraction comprising copolymers of ethylene with propylene or a C₄-C₁₀ alpha-olefin, optionally containing minor amounts of a diene.

10. The polyolefin composition of claim 1 further comprising a coupling agent c) in an amount of 0.1% to 10% by weight, referred to the total weight of a)+b)+c).

11. The polyolefin composition of claim 10, wherein the coupling agent is selected from homopolymers and copolymers of alpha-olefins containing polar groups.

12. A formed article comprising the polyolefin composition of claim 1.

13. The formed article according to claim 12, in the form of insulating layer of electrically conductive wires and cables.
